(19) United States
(12) Patent Application Publication
(10) Pub. No.: US 2011/0308161 A1
(43) Pub. Date: Dec. 22, 2011

(54) FIRE SHUTTER

(75) Inventors: David Leonard Cox, Windsor (AU); Gregory Donald Chapman, Everton Park (AU)

(73) Assignee: COX ARCHITECTS PTY LTD, Windsor (AU)

(21) Appl. No.: 13/166,071

(22) Filed: Jun. 22, 2011

(30) Foreign Application Priority Data
Jun. 22, 2010 (AU) 2010100647

(51) Int. Cl. E06B 5/00; E05B 65/06; E05F 11/02; E06B 3/38

(52) U.S. Cl. 49/324; 49/381; 49/366; 49/394

(57) ABSTRACT

A fire shutter for protecting an opening 10, such as a window 12, having one or more (typically two) fire resistant panels 20 and 21. The panels are hinged along a horizontal portion of the opening such that at least one of the panels can be utilised as an awning when open. The panel(s) have an insulating core that typically provides thermal insulation from the elements and increases fire resistance from fires (such as bushfires) to provide a fire rated shutter that meets the highest building fire standards.

### RELATED APPLICATION

This application claims priority under 35 U.S.C. §119(a)-(d) to Australian Application No. AU 2010100647, filed on Jun. 22, 2010, entitled “AN IMPROVED FIRE SHUTTER,” which is hereby incorporated by reference in its entirety for all purposes.

### BACKGROUND OF THE INVENTION

The invention relates to fire shutters and, more particularly to horizontally hinged, vertically opening, fire shutters comprising a thermally insulating material.

### BACKGROUND ART

[Mere reference to background art herein should not be construed as an admission that such art constitutes common general knowledge in relation to the invention.]

Fires, in particularly bushfires, can be a hazard to buildings/dwellings. Typically, such fires penetrate the weakest points of a building first and, once inside, can often find fuel to encourage the fire. This posses a significant threat to both the building/dwelling, the effects contained therein, and, more importantly, any people that may be inside.

One such weak point is in openings in the walls of the building, typically windows. Glass can easily be broken, particularly under extreme temperatures and, furthermore, is a poor thermal insulator meaning that radiant heat can still enter the building. To address this problem, shutters for windows can be utilised to cover the window. The shutters typically cover the window and are usually made of metal. When not in use, the shutters are usually stored on the sides of the window, or rolled into a roller assembly (e.g. much like a roller garage door).

Although a vast improvement on having no shutters, such shutters can conduct a significant amount of heat during a fire, and typically have little or no use when not protecting the opening/window from a fire, and are unsightly when not in their storage position.

It is an aim of this invention to provide an improved fire shutter which overcomes or ameliorates one or more of the disadvantages or problems described above, or which at least provides a useful alternative.

### BRIEF SUMMARY OF THE INVENTION

According to an aspect of the invention, there is provided a fire shutter for an opening, the fire shutter comprising:

at least one fire resistant panel having an insulating core, wherein the at least one panel is hinged along a horizontal portion of the opening, and is configured to cover the opening in a closed state and to be configurable as an awning in an open state.

The insulating core preferably substantially traverses the surface area of the panel, and in a preferred embodiment substantially fills an interior of the panel. The panel preferably has a hard outer casing or shell. The hard outer casing or shell may be made of any suitable, preferably fire resistant/proof material, such as a metal (preferably steel).

Preferably the insulating core comprises a phenolic foam. In an embodiment, the insulating core comprises a mixture of phenolic foam and polystyrene, preferably polystyrene beads. In a preferred embodiment, the insulating core comprises a product known as RMAX POLYPHEN which, when in a steel clad ‘sandwich’ panel can achieve the highest criteria for fire hazard properties of building materials and assemblies under the Building Code of Australia.

In an embodiment, the fire shutter comprises an upper panel hinged along an upper horizontal portion of the opening and a lower panel hinged along a lower horizontal portion of the opening. Preferably the upper and lower panels together can be configured to cover the opening in a closed state, and the upper panel alone is configurable as an awning in an open state.

The panels may be hinged from within a recess in a surface, preferably a wall, that the opening is within. Preferably when the panels are in the closed state they are contained within the recess with little or no extruding parts. When panels are in the open state they preferably at least partially (in a preferred embodiment, substantially) outside the recess and clear of the opening.

The join between the upper panel and the lower panel may be rebated (e.g. a rebated or stepped join). The join may be configured such that water, such as from rain, is prevented (or at least substantially inhibited) from entering the shutter. In an embodiment, the meeting ends of the upper panel and the lower panel each have a protruding portion that is received against an adjacent recessed portion in the other panel, and in a particularly preferred embodiment, the protrusion of the upper panel is on the exterior of the shutter and protrusion of the lower panel is on the interior of the shutter when the panels are in a closed state.

In an alternative embodiment, the lower panel may be pivotably connected to the upper panel, such that when opening the shutter, the lower panel folds relative to the upper panel to reside (at least substantially) adjacent the upper panel in the open state. Such an arrangement could also be used with the hinges along the vertical side of the panels, to cover a larger opening such as a sliding door.

Preferably, at least a portion of the edges of the panel have an intumescent coating. The intumescent coating is preferably an intumescent paint that is applied to at least the majority of the edges and/or joins of the panel(s). Where the panel is under severe heat, such as that caused by a nearby fire, the intumescent coating preferably expands or swells to seal the panel. Assuming the panel is in the closed state, the panel is preferably sealed in the opening to limit or prevent the fire, and preferably as much heat as possible, from passing into the opening.

The fire shutter may further comprise a mounting assembly. The mounting assembly may comprise a frame mounted within or adjacent the opening. Preferably, where there is a mounting assembly, the panels hinge from the mounting assembly. In an embodiment, the mounting assembly comprises a steel frame that substantially surrounds the perimeter of the opening.

Preferably the opening is a window and, even more preferably, the fire shutter is located on the exterior side of window panes. The window is preferably located in a wall and the recess preferably comprises at least a portion of the window frame. The panel(s) preferably have a latching or locking mechanism to latch/lock the panels in at least the closed state. The latching or locking mechanism can preferably be actuated from the inside.

The panel(s) may have one or more assistance mechanisms configured to assist in the opening and/or closing of the panels. The assistance mechanisms may comprise gas struts (particularly for the upper panel in a two panel embodiment), linkages, levers, electric motors, hydraulics, or the like. Preferably the panel(s) may be maintained in one or more states between the open and closed states (e.g. a partially open state). For instance, an upper panel may be maintained at different heights depending on, for example, the height of the sun, and the level of protection desired from the sun.

Preferably the panel(s) are more than 20 mm thick and less than 100 mm thick. Even more preferably, the panel(s) are between 40 and 60 mm thick and, in a preferred embodiment, the panel(s) are approximately 50 mm thick. A typical wall section may be 200 mm thick, with the window pane(s) recessed by approximately 80 mm from the exterior surface. Preferably the panel(s) pivot between 45° and 180° between the closed and open states. In a preferred embodiment, the upper panel pivots between 45° and 135°, preferably 90° (between the closed state to the open state); and the lower panel pivots approximately 180° (between the closed state to the open state).

Preferably the shutter is full fire rated, exceeding, or at least meeting, the highest and/or most stringent fire safety ratings and standards. In this regard, the shutter preferably exceeds fire rating guidelines and requirements under the relevant Building Code for example, the Building Code of Australia (e.g. vol. 2 classes 1 and 10, building provisions for extreme bushfire areas).

In order that the invention may be more readily understood and put into practice, one or more embodiments thereof will now be described, by way of example only, with reference to the accompanying drawings.

### BRIEF DESCRIPTION OF THE DRAWINGS

FIG. 1 illustrates a perspective view of an embodiment of the invention in an open state.

FIG. 2 illustrates a cross-sectional side elevation view of an embodiment of the invention in an open state.

FIG. 3 illustrates a cross-sectional side elevation view of an embodiment of the invention in a closed state.

FIG. 4 illustrates a close up cross-sectional side elevation view of a hinge portion according to an embodiment of the invention.

FIG. 5 illustrates a cross-sectional side elevation view of an embodiment of the invention in a closed state.

FIG. 6 illustrates a close up cross-sectional side elevation view of hinge and latching portions according to an embodiment of the invention.

### DETAILED DESCRIPTION OF THE INVENTION

Illustrated in the figures are embodiments of the invention having an upper panel 20 and a lower panel 21 covering an opening 10 in a wall 11. The opening is a window with panes 12 that may operate in any suitable manner but, in the illustrated embodiments are typically illustrated as sliding windows comprising two adjacent panes. Although two panels 20 and 21 are illustrated, it will be appreciated that a single panel (typically similar to the upper panel 20) could be provided in isolation, and no limitation is meant thereby.

The panels 20 and 21 are generally planar rectangular members having a steel shell and an insulating, fire resistant, core 20′ and 21′. The core 20′ and 21′ is made of a phenolic foam, which may have polystyrene beads contained therein. In a preferred embodiment the material is preferably RMAX POLYPHEN, which has been found to provide suitable structural and fire resistant properties.

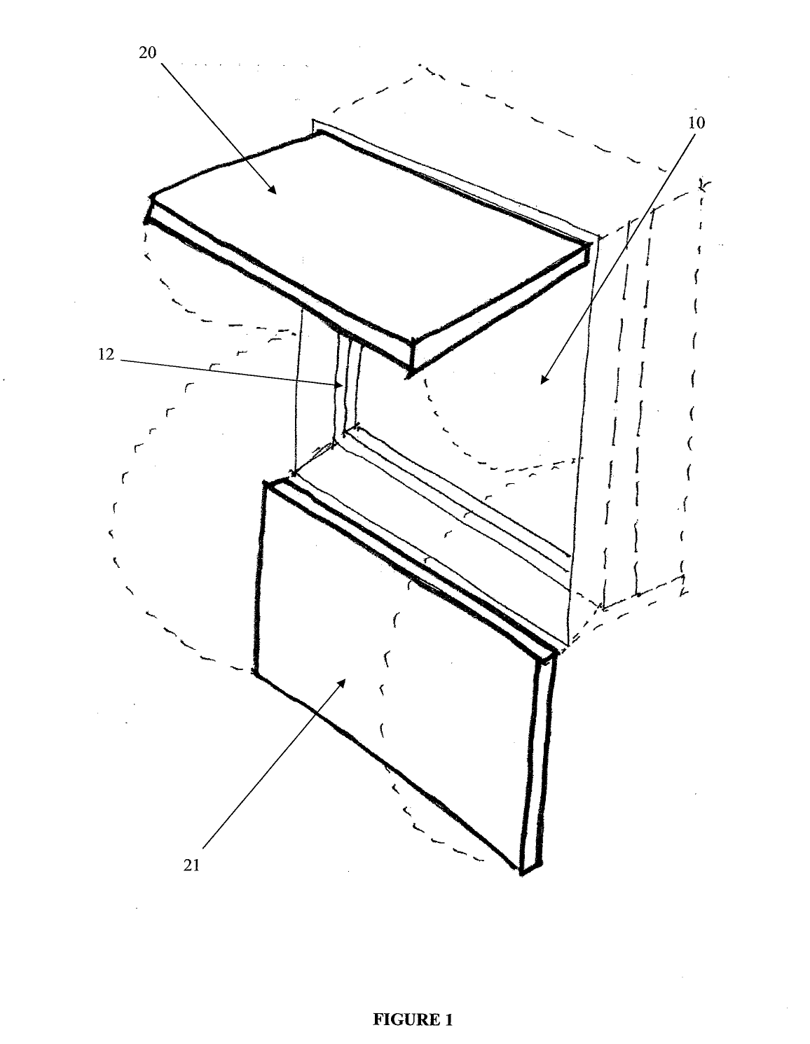

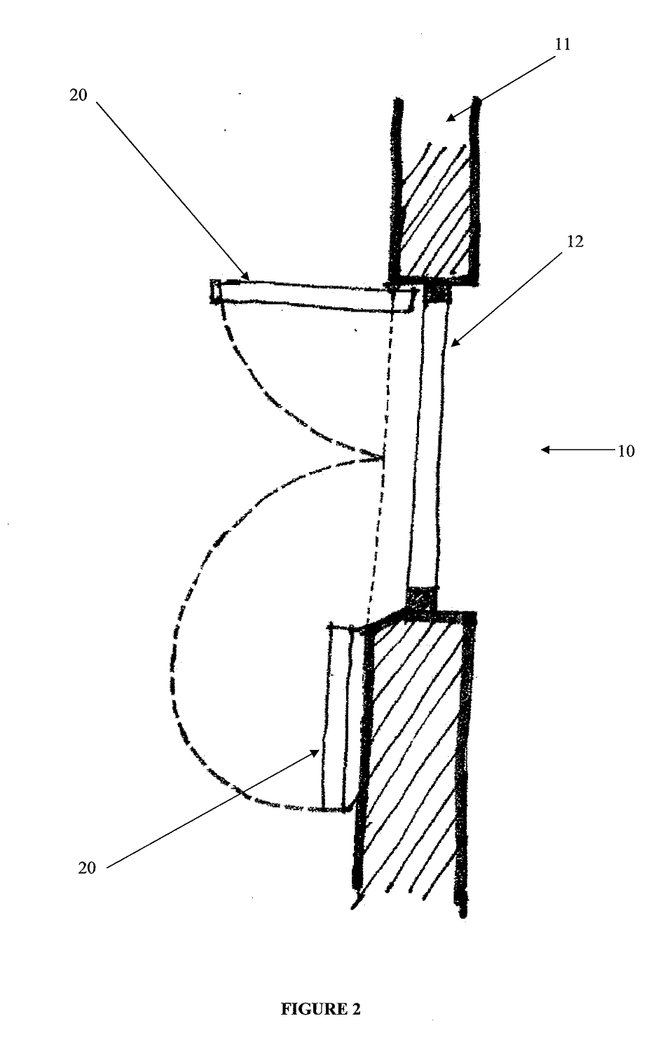

The panels 20 and 21 are hinged along a horizontal (or at least substantially horizontal) edge of the opening 10. As illustrated in FIGS. 1 and 2, the panels 20 and 21 are in an open (or at least partially open) state. The upper panel 20 extends perpendicularly from the wall 11 and can be utilised as an awning for the opening 10. The lower panel 21 folds back and rests adjacent the wall 10, generally out of the way. However, it is envisaged that the lower panel 21 could also extend perpendicularly and be used as a shelf, bench, bar top, or the like.

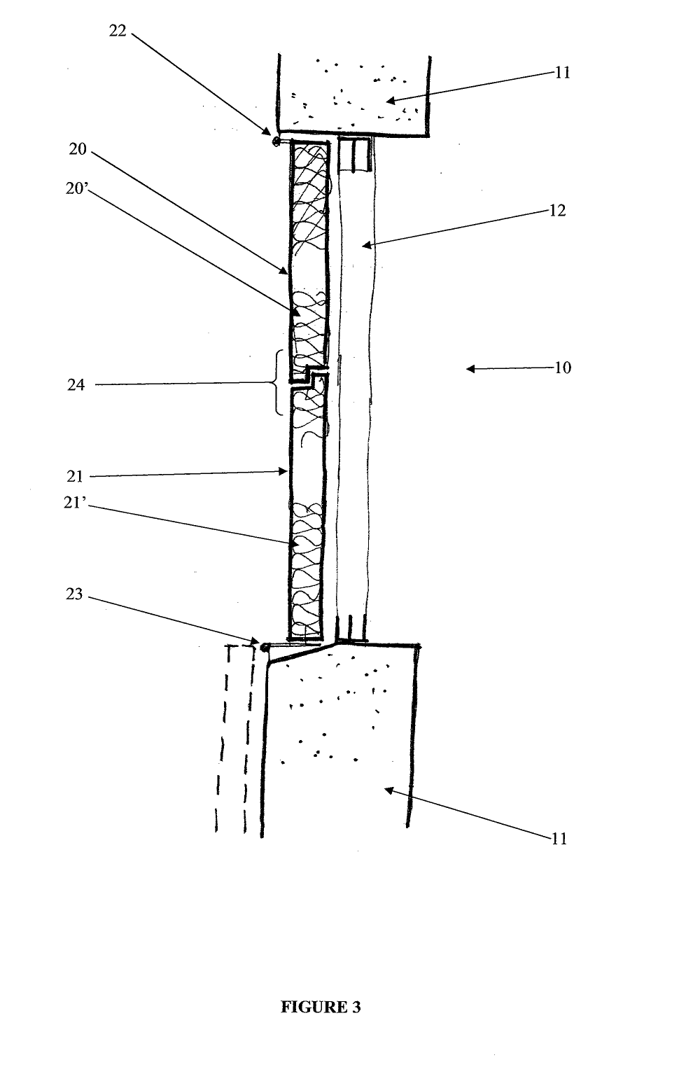

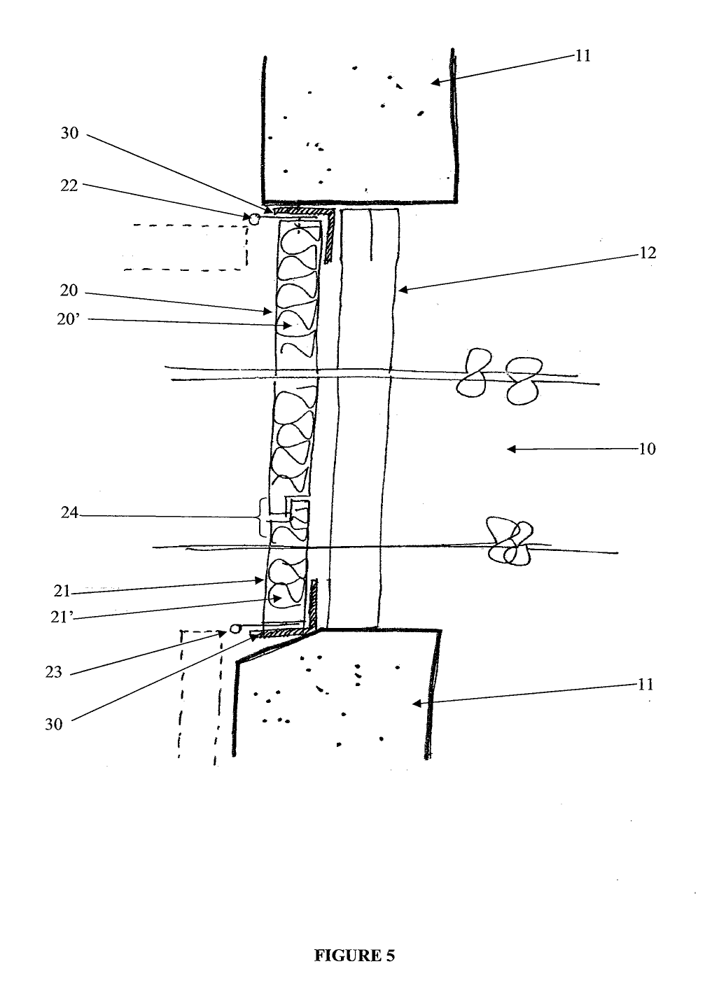

In the closed state, as illustrated in FIGS. 3 and 5, the panels 20 and 21 cover the opening. In the closed state, the shutter not only provides fire protection (e.g. from bushfires) but also provides thermal insulation, security, and can replace curtains, if desired. FIG. 5 not only illustrates the shutter in a closed state, but also illustrates preferred panel positions in an open state with the dashed lines.

As illustrated in FIG. 3, the panels 20 and 21 have a rebated join 24. The rebated join 24 provides a structural fit, as well as sealing one side of the panels from the other (i.e. the outside from the inside). The join 24 is configured such that the upper panel 20 has a protruding portion on the outer side that is received by a corresponding recessed portion in the lower panel 21. This ensures liquids, such as water, are unable to flow from the outside to the inside, at least not by gravity alone.

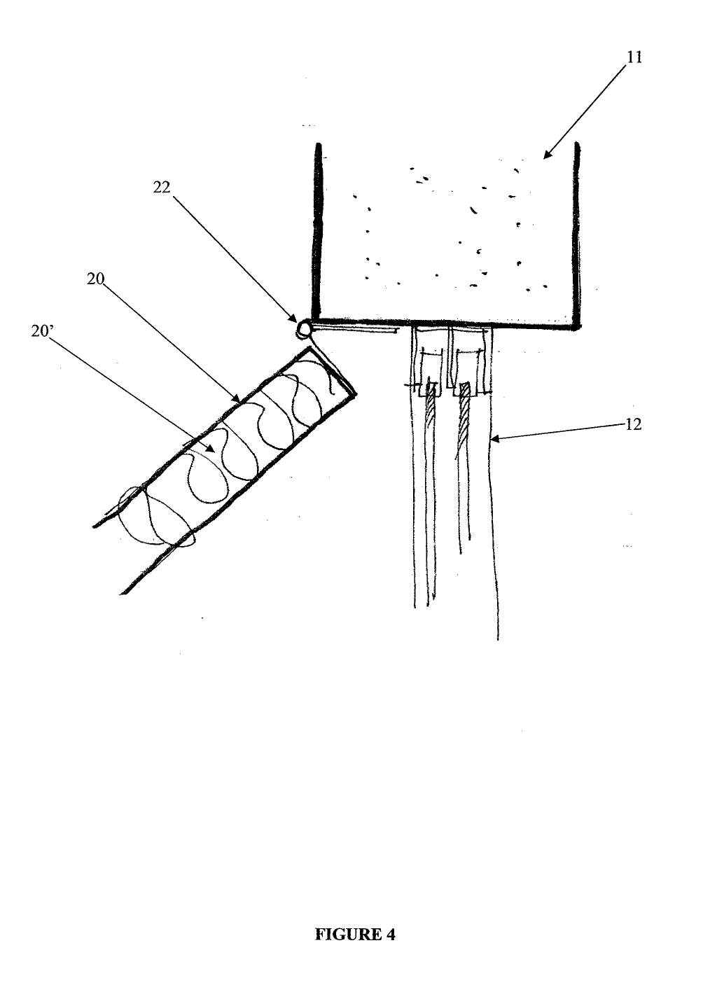

The panels 20 and 21 are hinged to the wall 11 by respective hinges 22 and 23, most clearly illustrated in FIG. 4. The hinges are arranged to allow the panels 20 and 21 to pivot around the horizontal axis, as shown by the curved dashed lines in FIGS. 1 and 2. As illustrated by the dashed lines in FIG. 5, the upper panel 20 pivots approximately 90° about the upper hinge 22, and the lower panel 21 pivots approximately 180° about the lower hinge 23.

At least the upper panel 20 has a retention mechanism (not illustrated) to retain the panel in the open state. The mechanism preferably allows the panel to be retained at different angles, allowing the upper panel 20 to be utilised as an adjustable awning. The lower panel 21 may also have such a mechanism. The panels 20 and/or 21 preferably have an assistance mechanism to assist in moving/pivoting the panels 20 and 21. The assistance mechanism may be any suitable mechanism, but preferably comprises gas struts (not illustrated) which assist in countering the weight of the panels during movement.

The gas struts may also form at least part of the retention mechanism. For example, the gas strut may be utilised to assist in moving the upper panel 20 from the closed state (as illustrated in FIG. 5) to the open state (as illustrated in the dashed lines in FIG. 5). Then, when in the open state, the gas strut is capable of holding the weight of the panel and retaining the panel in the open state. Furthermore, the gas strut may allow the panel to be moved to a desired angle (in between the open and closed states, or possibly extending beyond the open and closed states) and held at that angle by the gas strut.

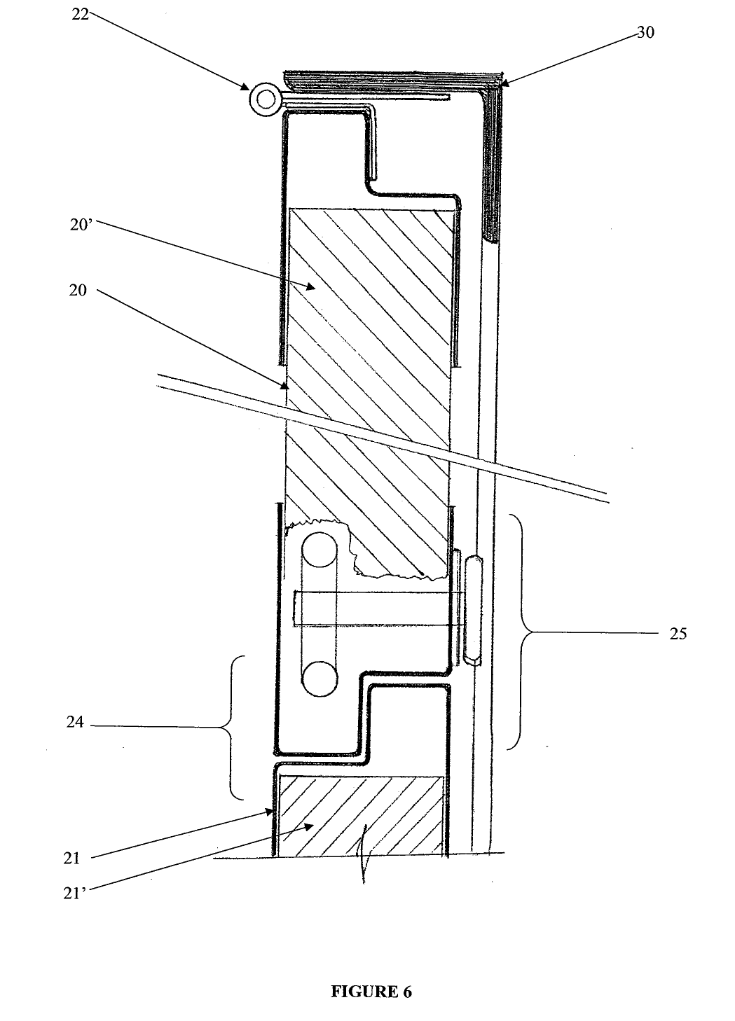

A mounting assembly in the form of a frame 30 may be provided in the opening 10 to mount the hinges/panels thereon. The frame 30 is preferably made of steel and substantially traverses the perimeter of the window frame 10. The frame 30 is illustrated in FIGS. 5 and 6, and is utilised as a support for the hinges 22 and 23 to be attached thereto. The frame 30 is preferably made of right angle steel extrusions, with a portion that sits adjacent the wall 10 and a portion that extends perpendicularly from the wall 10. The frame 30 provides a stable secure support for the panels 20 and 21, protects the hinges 22 and 23, and ensures a good seal between the panels 20 and 21 and the wall 11.

A latching mechanism 25 may be provided (FIG. 6), which latches or locks the panels 20 and 21 in the closed state. The latching mechanism 25 may latch/lock each panel individually, and/or may latch/lock the two panels together. The latching mechanism 25 not only secures the opening 10 (e.g. from intruders), but also holds the panels in place in event of emergency to prevent the shutter being inadvertently opened.

Advantageously, the shutter is multi-purpose, being a high level fire rated shutter to protect the inside of the opening 10 from fires (e.g. bushfires), but also being able to be used as an awning, and a security and thermally insulating window covering. In the event of a fire, the shutter keeps embers and radiant heat out. When there is no risk of fire, the upper panel 20 can become an awning, and the lower panel 21 may sit out of the way against the wall 10. If desired, the panels may be put in the closed position to provide thermal insulation (e.g. to keep warmth in, or out) as well as a level of security, particularly from intruders who would not be able to simply break the window if it is covered by the panels.

It is to be understood that the terminology employed above is for the purpose of description and should not be regarded as limiting.

The foregoing embodiments are intended to be illustrative of the invention, without limiting the scope thereof. The invention is capable of being practised with various modifications and additions as will readily occur to those skilled in the art.

Accordingly, it is to be understood that the scope of the invention is not to be limited to the exact construction and operation described and illustrated, but only by the following claims which are intended, where the applicable law permits, to include all suitable modifications and equivalents within the spirit and concept of the invention.

Throughout this specification, including the claims, where the context permits, the term “comprise” and variants thereof such as “comprises” or “comprising” are to be interpreted as including the stated integer or integers without necessarily excluding any other integers.

1. A fire shutter for an opening, the fire shutter comprising at least one fire resistant panel having an insulating core, wherein the at least one panel is hinged along a horizontal portion of the opening, and is configured to cover the opening in a closed state and to be configurable as an awning in an open state.

2. A fire shutter for an opening as claimed in claim 1 wherein the at least one panel is provided with an at least partially rigid outer casing or shell.

3. A fire shutter for an opening as claimed in claim 1 wherein the at least one panel is provided with an insulating core.

4. A fire shutter for an opening as claimed in claim 3 including an at least partially rigid outer casing or shell wherein the insulating core substantially fills the outer casing or shell.

5. A fire shutter for an opening as claimed in claim 1 wherein the fire shutter comprises an upper panel hinged along an upper horizontal portion of the opening and a lower panel hinged along a lower horizontal portion of the opening.

6. A fire shutter for an opening as claimed in claim 1 wherein the at least one fire resistant panel is hinged from a non-vertical surface defining the opening.

7. A fire shutter for an opening as claimed in claim 6 wherein when the panels are in the closed state they are contained within the opening inside the plane of a wall in which the opening is formed.

8. A fire shutter for an opening as claimed in claim 7 wherein when the at least one panel is in an open state, each at least one panel extends at least partially outside the opening.

9. A fire shutter for an opening as claimed in claim 1 wherein at least a pair of panels are provided and the panels at least partially overlap when in a closed condition.

10. A fire shutter for an opening as claimed in claim 9 wherein a partial thickness rebate is provided on an edge of each panel, the respective rebates overlapping when in a closed condition.

11. A fire shutter for an opening as claimed in claim 10 wherein an upper panel is provided with a rebate on an internal side of the edge and a lower panel is provided with a rebate on an external side of the edge.

12. A fire shutter for an opening as claimed in claim 1 wherein at least a pair of panels are provided and a second panel is pivotably connected to a first panel, such that when opening the shutter, the second panel folds relative to the first panel to reside at least substantially) adjacent the first panel in the open state.

13. A fire shutter for an opening as claimed in claim 1 wherein at least a portion of the edges of the panel have an intumescent coating.

14. A fire shutter for an opening as claimed in claim 13 wherein the intumescent coating is an intumescent paint applied to at least the majority of the edges and/or joins of the panel(s).

15. A fire shutter for an opening as claimed in claim 1 wherein the fire shutter includes a mounting assembly including a frame mounted within or adjacent the opening, the at least one panel hinged from the mounting assembly.

16. A fire shutter for an opening as claimed in claim 15 wherein the at least one panel has a latching or locking mechanism to latch/lock the at least one panel in at least a closed state.

17. A fire shutter for an opening as claimed in claim 1 wherein the at least one panel has one or more assistance mechanisms configured to assist in the opening and/or closing of the at least one panel.
